(19) United States
(12) Patent Application Publication
(10) Pub. No.: US 2007/0193271 A1
(43) Pub. Date: Aug. 23, 2007

(54) Methods of generating exergy

(76) Inventor: Alexander Gorban, Kiev (UA)

Correspondence Address: KENYON & KENYON LLP, 1500 K STREET N.W., SUITE 700, WASHINGTON, DC, 20005, US

(21) Appl. No.: 11/663,478

(22) PCT Filed: Sep. 29, 2004
(86) PCT No.: PCT/IB04/03165

§ 371 Date: Apr. 30, 2007

(51) Int. Cl. F01K 13/00; F01K 25/02; F02C 1/04; F02G 1/00

(52) U.S. Cl. 60/650; 60/645

(57) ABSTRACT

The invention relates to a process for transforming energy into exergy by supplying heat to a vaporous working substance subjected to an expansion and compression cycle and by obtaining the exergy in the expansion stage of the cycle. The cycle is performed in a single phase area of the vaporous working substance and working substance in liquid state is supplied to the cycle during the compression stage.

### BACKGROUND OF THE INVENTION

1. Field of the Invention

The invention relates to power-engineering and, in particular, to a method of generating exergy (efficient part of energy) by transforming heat into useful mechanical or electrical work.

More specifically, the invention relates to a method of transforming energy of a heat source into useful form through working substance, which expands and compresses in continually-cyclic thermodynamic power process. Heat is converted to useful mechanical and electrical exergy via homogeneous single-phase working substance in a dry vapour state. The working substance periodically expands and compresses while continually being in the area of vapour (e.g. aqueous vapour) without changing its state of aggregation, therewith transformation of supplied heat energy into useful work of expansion of superheated vapour in the area of large entropy is carried out.

The invention further relates to a method of increasing thermodynamic efficiency of transforming heat into work in thermodynamic steam power cycle and hence, to a new thermodynamic steam power cycle in which this method is used. The invention may be used in generating exergy through transforming heat into useful work in heat engines with vapour as a working substance, in heat plants, cogenerating apparatus and so on.

2. Description of the Related Art

Methods of generating exergy in steam power thermodynamic cycles of heat engines are well known, in which transformation of supplied heat power into work is carried out with the help of a working substance. The most commonly utilized thermodynamic cycle for producing useful energy from a heat source is the Rankine cycle on wet saturated vapour. In the Rankine cycle, a working substance such as water, ammonia or Freon is evaporated in an evaporator with an available heat source. The evaporated vaporous working substance is then expanded across a turbine to transform its energy into work. The spent vaporous working substance is then condensed in a condenser using available cooling medium. The pressure of condensate is then increased by pumping it to an increased pressure after which the working substance at high pressure is again evaporated, and so on to continue with the cycle. While the Rankine cycle is in considerable use, it has a relatively low efficiency due to moderate saturation temperatures and considerable heat loss during vapour condensation.

The improved thermodynamic cycles are also known, in which for similar application dry vapour superheating is used, e.g. the Girn cycle with single superheating of dry vapour, as well as cycles with continuous or multiple repetitive intermediate superheating of the dry vapour. Vapour superheating contributes to increase of an average temperature of heat supply to a working substance and to a rise of thermodynamic efficiency of the cycle.

The known methods of exergy generation by transforming supplied heat into work in thermodynamic steam power cycles have limited thermodynamic efficiency because of theoretically unavoidable heat loss as waste of a heat part of working substance during its phase transition in the process of condensation, with which in the steam power cycles variation of entropy of a heat source is compensated. In the Rankine and Girn cycles a thermal efficiency is no more than 0.3-0.5.

The closest technical solution to the proposed method is a method of exergy generation by transforming heat into work in the steam power thermodynamic cycle with superheated vapour, which is subject to another patent application of the same applicant.

The known methods of generating effective exergy utilizing superheated vapour have limited technical potentialities because of low thermodynamic efficiency of transforming heat into work, which prevents an increase of transformation efficiency due to substantial heat loss arising from exergy waste disposal outside a system during vapour condensation.

Thus, there is a need for a method and/or processing system providing a more efficient solution of the problems described above. Particularly, it is desirable to provide a method of more efficiently generating exergy in steam power cycles.

### SUMMARY OF THE INVENTION

In accordance with the invention, as embodied and broadly described herein, methods and systems consistent with the principles of the invention provide for transforming energy into exergy by supplying heat to a vaporous working substance subjected to an expansion and compression cycle and by obtaining the exergy in the expansion stage of the cycle, characterized in that the cycle is performed in a single phase area of the vaporous working substance and that working substance in liquid state is supplied to the cycle during the compression stage.

The methods in accordance with this invention and its embodiments are useful for generating a more efficient exergy in a steam power cycle of a heat engine utilizing alternate heating and cooling of a vaporous homogeneous working substance producing, a motive force with no return of the working substance to a liquid state, based on regenerative exergysaving (i.e. saving exergy of an energy carrier) transformation of supplied heat into useful work of a thermodynamic power cycle. In the exergy-saving cycle interaction of the three physical antipodes—entropy, exergy and energy in the cycle is radically changed as well as the structure of heat exchange and effectiveness of heat transformation into work is significantly increased in the thermodynamic cycles, which are carried out (meeting all the requirements of the first and second laws of thermodynamics) between temperature levels of the two heat sources but without heat waste and without heat (entropy) degradation of another source. This increases the thermodynamic effectiveness of the cycle.

In accordance with another aspect, the invention, as embodied and broadly described herein, methods and systems consistent with the principles of the invention provide vapour turbines according to claims 13 and 14.

Additional objects and advantages of the invention and its embodiments will be set forth in part in the description, or can be learned by practice of the invention. Objects and advantages will be realized and attained by means of the elements and combinations particularly pointed out in the appended claims. Embodiments of the invention are disclosed in the detailed description section and in the dependent and appended claims as well.

It is understood that both the foregoing general description and the following detailed description are exemplary and explanatory only and are not restrictive of the invention and its embodiments.

### BRIEF DESCRIPTION OF THE DRAWINGS

The accompanying drawings, which are incorporated in and constitute a part of this specification, illustrate examples of embodiments of the invention and, together with the description, explain the principles of the invention. In the drawings,

FIG. 1 shows for illustration purpose an entropy diagram explaining the nature of a method of exergy generation through thermodynamic transformation of heat supplied from the outside to the isothermal process of expanding and performing of external useful work in the steam power exergy saving cycle of standard type in coordinates T—temperature (ordinate) and S—entropy (abscissa).

FIG. 2 shows for illustration purpose a diagram explaining the nature of thermodynamic transformation of heat into work in the steam power exergy saving isothermal cycle of standard type in coordinates P—pressure (ordinate) and V—volume (abscissa).

FIG. 3 shows for illustration purpose a diagram explaining the nature of thermodynamic transformation of heat into work in power gaseous exergy saving isothermal cycle of standard type in coordinates i—enthalpy (ordinate) and S—entropy (abscissa).

FIG. 4 shows for illustration purpose a block diagram of realization of a method of thermodynamic multistage transformation of heat supplied from the outside in the isochoric conditions into work in the steam power exergy saving cycle of standard type.

FIG. 5 shows for illustration purpose an entropy diagram explaining the nature of a method of exergy generation through thermodynamic transformation of heat supplied from the outside to the isochoric-isobaric processes of expanding and fulfilment of external useful work in the adiabatic processes of the steam power exergy saving cycle of standard type in coordinates T—temperature (ordinate) and $—entropy (abscissa).

FIG. 6 shows for illustration purpose a block diagram of a realization of a method of exergy generation through multistage transformation of heat supplied in the isochoric-isobaric processes in the steam power cycle carried out with a vaporous homogeneous working substance, e.g. aqueous vapour, which multistage expands in the adiabatic processes, therewith transformation of heat energy into another useful form—mechanical work and further into electrical work is carried out.

### DESCRIPTION OF PREFERRED EMBODIMENTS

Reference will now be made in detail to the principles of the invention by explaining the invention on the basis of a thermodynamic steam cycle process, examples of which are illustrated in the accompanying drawings. Examples, mentioned therein, are intended to explain the invention and not to limit the invention in any kind.

According to the invention and its embodiments, an initial flux of a dry saturated vaporous working substance may be created, which may perform a steam power cycle in a single phase area with no change of its aggregate state. At the stage of compression of vaporous working substance, some part of the working substance in liquid state may be additionally injected into a compression cavity, and which injected substance may completely evaporate in the compression cavity with heat removal of heating of the working substance under compression. The amount of the injected liquid working substance may advantageously be regulated at each instant of time such that a process of compression of the vaporous working substance is provided along a boundary line of vapour, namely, along the line of condensation of dry saturated vapour, for which a vapour quality x=1, where x—vapour content or vapour quality, dimensionless quantity equal to the relation of mass of the dry saturated vapour to mass of the wet vapour, taking the value from x=0 (boiling liquid at boiling line) to x=1 (dry saturated vapour at condensation line). The working substance may be subjected to heating at the compression stages; it may be subjected to superheating at the stage of a regenerative heat exchange before the stage of expanding. The working substance may be expanded in a detander with performing useful work. In the process of expanding the pressure of the vaporous working substance is taken down to the low pressure level of the spent flux to transform its energy into useful form. Simultaneously a circular nonreciprocal regenerative transmission of the working substance into initial state takes place with performing full regenerative exchange by thermal exergy of the working substance not on the adjacent sections of the steam power cycle but on the opposite ones.

Accordingly, a further preferred embodiment is characterized in that the amount of supplied liquid working substance is regulated such that the compression is at least partially performed along the condensation line of the saturated dry vaporous working substance.

A further preferred embodiment is characterized in that the working substance is subjected to superheating before (21) the stage of expansion (19).

In a further embodiment the invention comprises the expansion is performed isothermically.

A further preferred embodiment comprises that the working substance is subjected to multistage isobaric superheating and subjected to multistage adiabatic expansion.

Another embodiment is characterized in that the working substance is subjected to multistage isochoric superheating and subjected to multistage adiabatic expansion.

A further preferred embodiment comprises that the cycle, when described by means of the thermodynamic T-S-diagram, comprises steps of:

isobaric compression from a point 2 (T3, S4) to a point 3 (T1, S3);

compression along the condensation line from the point 3 to a point 4 (T2, S1);

isochoric superheating from the point 4 to a point 1 (T3, S2);

isothermal or multistage expansion from point 1 to point 4;

T and S being temperature and entropy, respectively, with T3>T2>T1,

P 3 and P 4 being points on the condensation line below the critical point,

P 1 and P 2 being in the single phase region.

In a further preferred embodiment, the vaporous working substance may be isothermically expanded at the expansion stage in a detander.

In a further preferred embodiment, the vaporous working substance may be subjected to adiabatic multistage expansion at the expansion stage in a detander.

In a further preferred embodiment, the vaporous working substance may be subjected to multistage superheating at the expansion stage at constant volume.

In a further preferred embodiment, the circular transition of the vaporous working substance into initial state after expansion in a detander may be made through another heat source with regeneration of thermal exergy of nonreciprocal transitions and irreversible increasing of its entropy in the temperature field of the another heat source without external heat supply and without performing work. In an exemplary implementation of this process, regeneration of exergy of the working substance may be carried out not on the adjacent sections of the steam power cycle but on the opposite ones, performing balance of thermal exergy of the vaporous working substance during combined heat exchange within the system in going from the boundary state of the working substance to the state of the initial flux through the temperature field of the other adiabatic heat source. Compensation of entropy change may be performed in the irreversible process of continually-cyclic variation of entropy of the working substance.

In a further preferred embodiment, the working substance may be heated below the level of its critical point at the stage of compression, and heating of the working substance in the compressor, and superheating of the working substance prior to the stage of expanding and at the expansion stages are carried out isochorically in the field of dry saturated vapour.

In a further preferred embodiment, irreversible continually-cyclic variation of entropy of the working substance may be carried out by changing its thermal energy in the temperature field of a heat source. For this purpose the volume of the working substance may be irreversibly changed at constant pressure and temperature in the temperature field of the heat source, and regenerative heat exchange in the process of nonreciprocal transitions may be performed as combined exchange by thermal exergy of the working substance not on the adjacent sections of cycle but on the opposite ones.

Furthermore, combined regenerative exchange of the vaporous working substance within the power thermodynamic cycle may be carried out by thermal exergy transfer of the working substance from isobaric process to isochoric one not on the adjacent sections within the steam power cycle but on the opposite ones according to the equation:
1+lnΠ_{T(ΔP=0)}=Π_{T(ΔS=0)}(1+(1/k)*lnΠ_{T(ΔV=0)})
where: Π_{T(ΔP=0)}—extent of temperature decreasing in the isobaric process;

Π_{T(ΔV=0)}—extent of temperature increasing in the isochoric process;

k—specific heat ratio.

A further preferred embodiment comprises that the circular transition of the vaporous working substance in an initial state after expanding in a detander is at least partially carried out through a heat source with ideal regeneration of thermal exergy of nonreciprocal transition and irreversible increasing of its entropy in the temperature field of the heat source without external heat supply and without performing work.

In this embodiment, ideal regeneration of exergy of the working substance may advantageously be made not on the adjacent sections of the steam power cycle but on the opposite sections. Performing balance of thermal exergy of the vaporous working substance during combined heat exchange within the steam power cycle in going of the working substance from the boundary state to the state of the initial flux through the temperature field of the other, adiabatic heat source, and compensation of entropy variation is made in the irreversible process of continually-cyclic variation of entropy of the working substance.

Reference will now be made in detail to the principles of the invention and its embodiments by an explanation on the basis of a thermodynamic steam cycle process, examples of which are illustrated in the accompanying drawings. Examples, mentioned therein, are for explanatory purpose only and shall not to limit the invention in any kind.

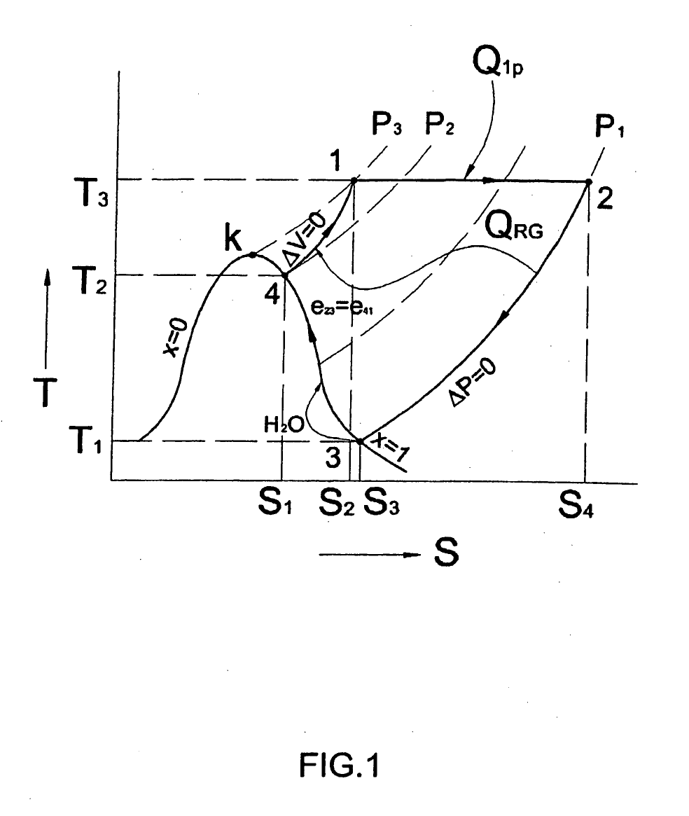

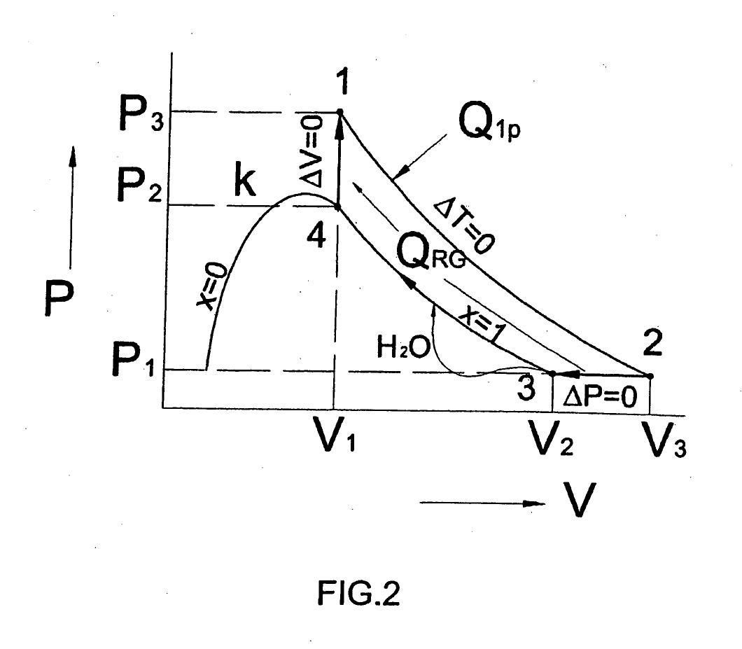

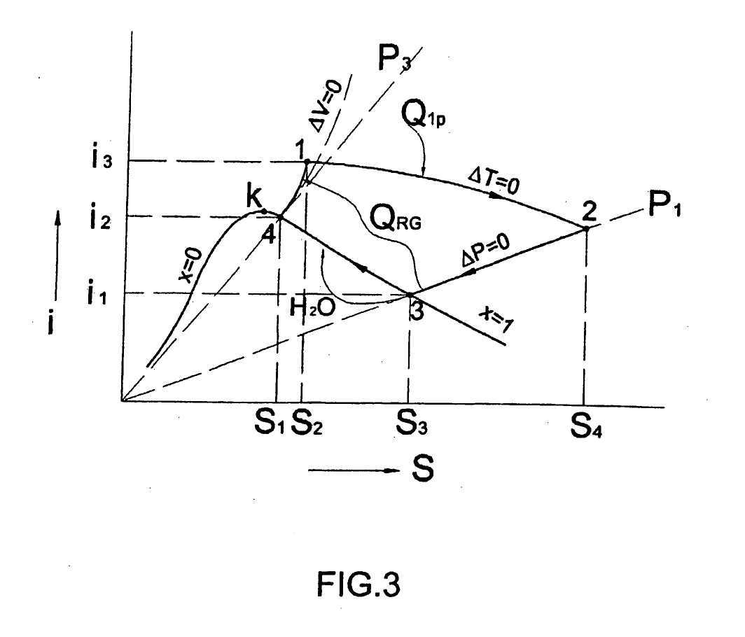

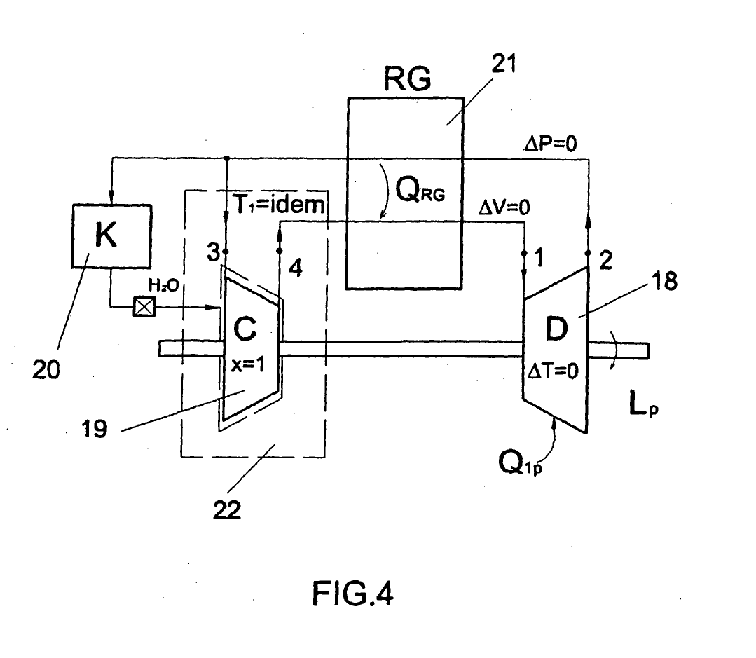

In the diagrams of FIGS. 1, 2, 3 and block diagram of FIG. 4 alternative realization of the method in the steam power exergy saving cycle of normal type with isochoric expansion is shown. In the diagrams illustrated in FIGS. 1, 2, 3 the same direct power exergy saving cycle is shown but in different coordinate systems, TS—diagram in coordinates T—temperature (ordinate) and S—entropy (abscissa) in FIG. 1, PV—diagram in coordinates P-pressure (ordinate) and V-volume (abscissa) in FIG. 2, iS—diagram in coordinates S—entropy (abscissa), I—enthalpy (ordinate), in which the following sections are designated:

4, 1—section of isochoric process (with constant volume, ΔV=0), running with supplying exergy Q_{RG} from isobaric section 2, 3, with exergy balance performing: e_{2,3}=e_{4,1};

2, 3—section of isobaric (with constant pressure, ΔP=0) process in temperature range T₃ T₁, with taking away thermal exergy Q_{RG} to isochoric process 4, 1;

3, 4—section of the vapour boundary compression process in temperature range T₂-T₁ with liquid fraction injecting (with constant vapour quality, equal x=1) running with absorption of superheating heat Q₁ₚ;

1, 2—section of Isothermal (with constant temperature of vapour T₃) expansion of gaseous phase in detander 18 with supplying external heat Q₁ₚ.

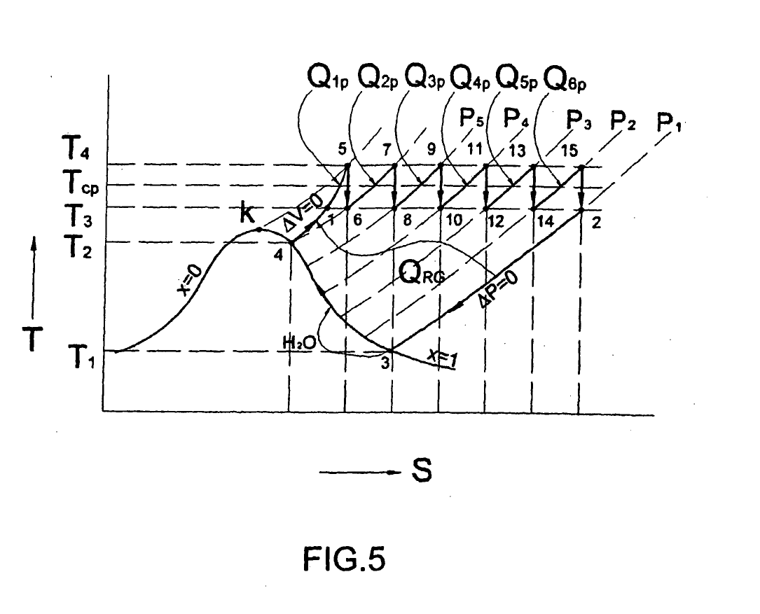

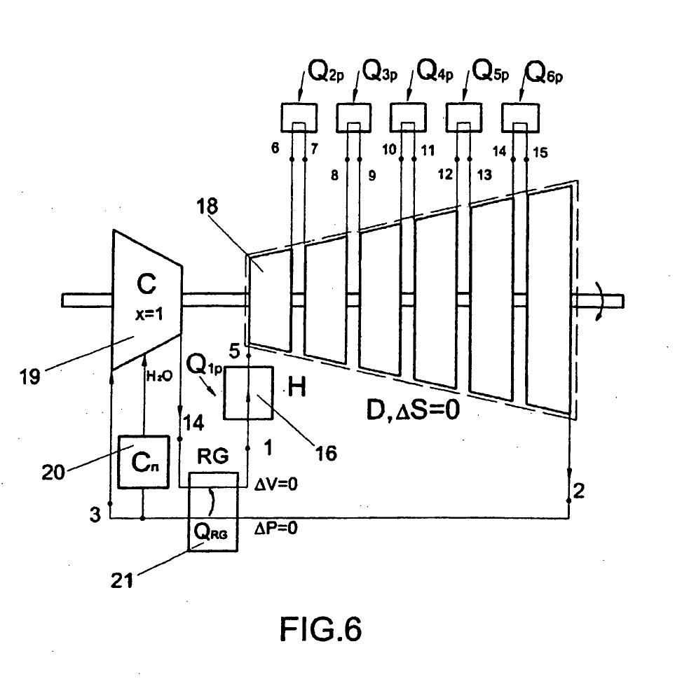

A diagram of FIG. 5 and block diagram of FIG. 6 illustrate a version of realization of the method in a combined steam power exergy saving cycle of standard type with isochoric multistage heating and adiabatic multistage expansion with additionally designated sections:

1, 5—section of isochoric vapour heating (in condition of constant value, ΔV=0) in a heater 16, with heat supply.

5,6; 7,8; 9,10; 11,12; 13,14; 15,2—sections of multistage additional adiabatic (with constant entropy, ΔS=O) vapour expansion in stages of detander 1.

6, 7; 8, 9; 10, 11; 12, 13; 14, 15—sections of multistage additional isobaric (at constant pressure ΔP=0) vapour superheating in vapour superheaters 17 between stages of vapour expansion in detander 18.

The offered method of generating exergy in the steam power thermodynamic cycle with isothermal heat supply on expansion of homogeneous vapour may be realized in the following manner:

An initial flux of a dry saturated vaporous homogeneous working substance is formed, which may perform steam power cycle in a single phase area with no change of its aggregate state. A scheme of realization of the method in the power exergy saving cycle of a heat machine of FIG. 4 with isothermal heat supply and expansion is given in diagrams of FIGS. 1, 2, 3. The method includes the stages of vapour compression in a compressor 19 (section 3, 4) with simultaneous injection of certain amount of water in the compressor with the help of a device of unit 20, combined regenerative heating of vapour in regenerator 21 (section 4, 1), isothermal expansion of vapour in detander 18 with supplying to it external heat Q₁ₚ.

At the stage 3, 4 compression of the vaporous working substance, which is realized with compressor 19, and working substance heating below level of its critical point take place. To provide compression along boundary line of vapour—line of condensation of dry saturated vapour, for which vapour quality x=1, some part of the working substance in liquid state is additionally injected by unit 20 into compression cavity of compressor 19, it is evaporated in the compression cavity of compressor 19 with removal of superheating heat, the amount of injected liquid substance is regulated at every instant, and the compression process of the vaporous working substance is carried out along the boundary line of vapour—line of condensation of dry saturated vapour, for which vapour quality r-1. At the compression stage, vapour is subjected to heating and vapour temperature increases from value T₁ to value T₂, which is below level of its critical point k.

At the stage of regenerative heat exchange in regenerator 21 (section 4,1) vapour is subjected to nonreciprocal regenerative superheating before the stage of expansion, to do this, heat from section 2,3 is used with completing exergy balance.

At the stage of expansion (section 1, 2) the vaporous working substance is isothermally expanded in detander 18 and mechanical exergy of vapour performs useful work Lₚ. The pressure of the vaporous working substance in the expansion process is taken down to the level of low pressure of spent flux (point 2 in FIG. 2) to transform its energy into useful form.

At the stage of regenerative exchange circular transition of the vaporous working substance in the initial state (after expanding in detander 18) is carried out through another heat source 21 with ideal regeneration of thermal exergy of nonreciprocal transitions. To do this, ideal regeneration of exergy of the working substance is performed out of adjacent parts of the steam power cycle (3,2 and 4,1) with completing exergy balance e_{2,3}=e_{4,1} of the vaporous working substance in combined heat exchange within the steam power cycle. Compensating irreversible increase of entropy in temperature field of the another heat source 21 is effected without external heat supply and without work performing. In transition from the boundary state of the working substance to the state of the initial flux over the temperature field of the adiabatic heat source 21, compensation of entropy variation is performed in the irreversible process of continually-cyclic variation of entropy of the working substance.

Thermal exergy of vapour after detander 18, in the process of circular nonreciprocal regenerative transition of the working substance in the initial state, is carried off from isobaric (ΔP=0) process 2, 3 to isochoric (ΔV=0) process 4, 1, therewith full exchange of thermal exergy of the working substance takes place out of adjacent parts of the steam power cycle, between sections 2, 3 and 4, 1 with complying exergy balance e_{2,3}=e_{4,1}.

Thermomechanical exergy is calculated by equation:
e=Δi−ΔST₁

where: Δi,ΔiS—variations of enthalpy and entropy, which equal, respectively:

Δi=CₚΔT; ΔS=C_{V} ln(T₃/T₂)—when ΔV=0 in isochoric process;

Δi=CPΔT; ΔS=CP ln(T3/T1)—when ΔP=0 In isobaric process;

Δi=0; ΔS=R ln(P3/P1)=R ln(V3/V1)=R In ΠP=R ln ΠV—when ΔT=0 in isothermal process;

Δi=CPΔT; ΔS=0—in isentropic process;

Δi=O; ΔS=R(ΔV/V)=mR—when ΔP=0, ΔT=0;

T3,T1—temperature of sources of high and low temperature, respectively;

R=CP-CV—gaseous constant;

k=CP/CV—specific heat ratio;

Cv,CP—gaseous heat capacity when V=const. or P=const.;

U—internal energy referred to 1 kg of substance.

When regeneration takes place at the opposite 2,3 and 4,1 parts of cycle 1,2,3,4 of FIG. 1, the equation of exergy balance e_{2,3}=e_{4,1}, in view of equations may be written as:
(i₃−i₁)−T₁(S₃−S₁)=(i₃−i₂)−T₂(S₂−S₁).
and this, after substitutions
C_{P}(T₃−T₁)−T₁C_{P} ln(T₃/T₁)=C_{P}(T₃−T₂)−T₂C_{V} ln(T₃/T₂)
and transformations, gives:
T₁(1+ln(T₃/T₁))=T₂(1+1/k*ln(T₃/T₂))
or,
1+ln Π_{T(ΔP=0)}=Π_{T(ΔS=0)}(1+1/k*l ln Π_{T(ΔV=0)})

Thus, combined regenerative nonreciprocal heat exchange of the vaporous working substance within the power thermodynamic cycle is affected through thermal exergy transmission of the working substance from the isobaric process to isochoric one out of adjacent sections within the steam power cycle according to the equation:
1+ln Π_{T(ΔP=0)}=Π_{T(ΔS=0)}(1+1/k*ln Π_{T(ΔV=0)})
where:

Π_{T(ΔP=0)}—extent of temperature decreasing in the isobaric process 2,3;

Π_{T(ΔV=0)}—extent of temperature increasing In the Isochoric process 4,1;

k—specific heat ratio.

Irreversible continually—cyclic variation of entropy of the working substance is effected through changing its thermal anergy in temperature field of the another source 21, for this purpose volume of the working substance is irreversible changed under its constant pressure and temperature in temperature field of the another source 21, and regenerative heat exchange in the process of nonreciprocal transitions is carried out as combined exergy exchange of the working substance out of adjacent sections of the steam power cycle.

The offered method of generating exergy in the steam power thermodynamic cycle with isochoric heating and multistage isobaric superheating, and adiabatic expansion is carried out according to a scheme of realization of the method in the power exergy saving cycle of closed heat machine of FIG. 6, given on TS—diagram of FIG. 5. It includes sections of regenerative isobaric-isochoric heat exchange 2,3 and 4,1, section 4,3 of compression of the vaporous working substance realizable with compressor 19 and isochoric heating of the working substance below level of its critical point. To carry out compression along boundary line of vapour—line of condensation of dry saturated vapour, for which vapour quality x=1, some part of the working substance in liquid state is additionally injected by unit 20 into compression cavity of compressor 19, it is advantageously fully evaporated in the compression cavity of compressor 19 with removal of superheating heat. The amount of injected liquid substance is regulated at every instant, and the compression process of the vaporous working substance is provided along the boundary line of vapour—line of condensation of dry saturated vapour, for which vapour quality x=1. At the compression stage vapour is subjected to heating, therewith vapour temperature increases from value T₁ to value T₂, below level of its critical point k.

At the stage of regenerative heat exchange in regenerator 21 (section 4,1) vapour is subjected to heating from temperature T₂ to temperature T₃ prior to expanding stage for which purpose heat from section 2,3 is used. At the stage of regenerative heat exchange, the circular transition of the vaporous working substance into the initial state (after expanding in detander 18 up to point 2) is carried out through another heat source 22 with advantageously ideal regeneration of thermal exergy of nonreciprocal transitions and irreversible increase of its entropy in a temperature field of another heat source with no heat exchange and work execution. For this purpose, ideal regeneration of exergy of the working substance is completed not on the adjacent sections 2,3 and 4,1 of the power cycle but on the opposite ones with carrying out exergy balance of the vaporous working substance during combined heat exchange within the steam power cycle at transitions from a boundary state of the working substance to a state of the initial flux through the temperature field of another adiabatic heat source. Entropy change compensation is carried out in the irreversible process of continually-cyclic entropy variation of the working substance.

Difference of the diagram of FIG. 5 from above-mentioned diagram of FIG. 1 lies in the fact that the vaporous working substance after regenerative isochoric heating in the section 4,1, prior to the stage of adiabatic extension in the stages of the detander 18, is subjected to isochoric superheating from temperature T₃ to temperature T₄ under constant volume in a superheater 16 in a section 1,5 as well as to multistage isobaric superheating from temperature T₂ to temperature T₄ with constant pressure in superheaters 17 which are put between stages of the detander 18 in the sections 8,7;8,9;10,11;12,13;14,15, and it is subjected to adiabatic multistage expansion in the sections 5,6;7,8;9,10;11,12;13,14;15,2 in expansion stages of the detander 18. Isochoric superheating and multistage isobaric superheating, and adiabatic expansion at the expansion stages are carried out in the field of dry saturated vapour.

External heat Q₁ₚ may be supplied to the superheater 16,17 from sources of fire heating. Heat may also be generated as a result of catalytic exothermic permutoidal oxidation of hydrocarbonic gases due to chemical interaction with porous—metallic or ceramic material of a superheater. Heat may also be generated by nuclear heat sources or such natural heat sources as the Sun, the Earth, an ocean, or by sources of recoverable energetic resources.

At the expansion stages the vaporous working substance is expanded at the stages of the detander 18 with maximum approach to isothermal expansion at mean temperature T_{cp}, therewith mechanical exergy performs useful work. In the expansion process, the pressure of the vaporous working substance is brought down to the level of low pressure P₁ of the spent flux (point 2 of FIG. 5) to transform its energy into useful form.

It is significant that vapour compression along condensation line with injection of a liquid and detander work in the field of large entropy requires special 3-D (three-dimensional) compressors and detanders capable of providing similar work modes. The invention has the advantage of increasing thermal and exergy efficiency of the steam power cycles because of decreasing heat loss of the cycles when realizing isothermal or adiabatic alternative method of generating exergy according to the invention.

The invention complies with condition of protection “Industrial applicability”, for it is realizable with employing known production means and existing technologies.

Modifications and adaptations of the present invention will be apparent to those skilled in the art from consideration of the specification and practice of the invention disclosed herein. The foregoing description of an implementation of the invention has been presented for purposes of illustration and description. It is not exhaustive and does not limit the invention to the precise form disclosed. Modifications and variations are possible in light of the above teachings or can be acquired from the practicing of the invention. It is intended that the specification and examples be considered as exemplary only, with a true scope and spirit of the invention being indicated by the following claims

1. A method for transforming energy into exergy by supplying heat to a vaporous working substance subjected to an expansion and compression cycle and by obtaining the exergy in the expansion stage of the cycle, wherein:
the cycle is performed in a single phase area of the vaporous working substance and
working substance in liquid state is supplied to the cycle during the compression stage.

2. The method of claim 1, wherein the amount of supplied liquid working substance is regulated such that the compression is at least partially performed along the condensation line of the saturated dry vaporous working substance.

3. The method of claim 1, wherein the working substance is subjected to superheating before the stage of expansion.

4. The method of claim 1, wherein the expansion is performed isothermically.

5. The method of claim 4, wherein the working substance is subjected to multistage isobaric superheating and subjected to multistage adiabatic expansion.

6. The method of claim 4, wherein the working substance is subjected to multistage isochoric superheating and subjected to multistage adiabatic expansion.

7. The method of claim 4, wherein the cycle, when described by means of the thermodynamic T-S-diagram, comprises the steps of:
isobaric compression from a point 2 (T3, S4) to a point 3 (T1, S3);
compression along the condensation line from the point 3 to a point 4 (T2, S1);
isochoric superheating from the point 4 to a point 1 (T3, S2);
isothermal or multistage expansion from point 1 to point 4;
T and S being temperature and entropy, respectively, with T3>T2>T1,
P 3 and P 4 being points on the condensation line below the critical point,
P 1 and P 2 being in the single phase region.

8. The method of claim 1, wherein the circular transition of the vaporous working substance in an initial state after expanding in the detander is at least partially carried out through a heat source with ideal regeneration of thermal exergy of nonreciprocal transition and irreversible increasing of its entropy in the temperature field of the heat source without external heat supply and without performing work.

9. The method of claim 1, wherein the working substance is heated below the level of its critical point at the stage of compression, and wherein heating of the working substance, isochoric superheating of the working substance prior to the stage of expansion and multistage isobaric superheating of the working substance at the stage of expansion are carried out in the field of dry saturated vapour.

10. The method of claim 1, wherein an irreversible continually-cyclic variation of entropy of the working substance is carried out by changing its thermal anergy in the temperature field of another source.

11. The method of claim 1, wherein the volume of the working substance is irreversibly changed at constant pressure and temperature in the temperature field of another source, and wherein regenerative heat exchange in the process of nonreciprocal transitions is performed as combined exergy exchange of the working substance on not adjacent sections of the steam power cycle.

12. The method of claim 1, wherein combined regenerative heat exchange of the vaporous working substance within the power thermodynamic cycle is carried out through transmission of thermal exergy of the working substance from an isobaric process to an isochoric one not on the adjacent sections within the steam power cycle but on the opposite ones according to the equation:
1+ln Π_{T(ΔP=0)}=Π_{T(ΔS=0)}(1+(1/k)*ln Π_{T(ΔV=0)})
where:
Π_{T(ΔP=0)}—extent of temperature decreasing in the isobaric process;
Π_{T(ΔV=0)}—extent of temperature increasing in the isochoric process;
k—specific heat ratio.

13. A vapor turbine for performing the method claim 1 comprising a compression stage and an expansion stage, wherein:
the compression stage comprises an injection device for supplying liquid working substance into the cycle and
the expansion stage comprises a heating device for maintaining a constant temperature in at least part of the expansion stage.

14. A vapor turbine for performing the method claim 1 comprising a compression stage and an expansion stage, wherein:
the compression stage comprises an injection device for supplying liquid working substance into the cycle and
the expansion stage comprises a multiple stage expansion stage, each stage comprising an isolation device for allowing adiabatic expansion of the working substance and a heating device for superheating the working substance.
